(19) United States
(12) Patent Application Publication
(10) Pub. No.: US 2007/0166126 A1
(43) Pub. Date: Jul. 19, 2007

(54) APPARATUS FOR SECURING SIDING

(76) Inventor: Donald HARNEY, Woodward, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 11/306,880

(22) Filed: Jan. 13, 2006

(51) Int. Cl. F16B 23/00; F16B 35/06

(52) U.S. Cl. 411/402

(57) ABSTRACT

An apparatus for securing vinyl siding to a surface having a head and a shaft that extends outwardly from the head and terminates in a tip. The shaft has a substantially smooth portion adjacent the head and a threaded portion that extends from the smooth portion toward the tip. The smooth portion is received within a slot in the vinyl such that the vinyl may slide longitudinally along the length of the slot in relation to the screw.

### BACKGROUND OF THE INVENTION

This invention is directed toward an apparatus for securing siding, and more particularly to a screw for securing siding over a steel stud.

Vinyl siding is known in the art and has a plurality of slots through which a plurality of fastening devices such as nails and screws are inserted through the slots to secure the siding to the mounting surface. To apply the siding over a steel stud generally a non-corrosive self-tapping screw is inserted through the slot of the vinyl and screwed into a wall sheathing that is installed over the studs. A problem exists in that the vinyl must be able to expand and contract to avoid bubbling or twisting. Because the self-tapping screw has threads that extend the length of the shaft, the edges of the slot become stuck in the grooves of the threads. As a result, the siding will not slide in relation to the screw. This is particularly the case with a fold that has a pair of slots in spaced alignment. Therefore, a need exists in the art for a screw that improves upon this problem.

A principal objective of this invention is to provide a screw that is inserted through a vinyl siding slot that allows the siding to slide in relation to the screw.

This and further objectives will be apparent to those skilled in the art based on the following description.

### BRIEF SUMMARY OF THE INVENTION

An apparatus or screw for securing vinyl siding to a surface having a head, a shaft extending from the head having a substantially smooth portion adjacent the head and a threaded portion extending therefrom. The shaft terminating in a point. The smooth portion of the shaft is positioned such that when the screw is inserted through a slot in vinyl siding the edges of the slot will slide over the smooth portion along the length of the slot.

### BRIEF DESCRIPTION OF THE DRAWINGS

FIG. 1 is a perspective view of siding being secured with a screw; and

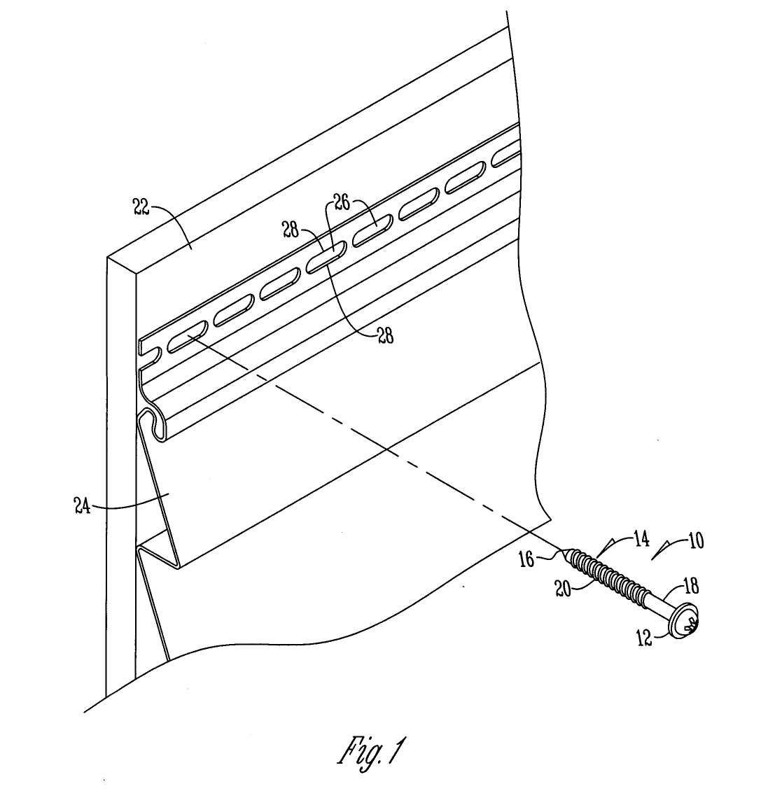

FIG. 2 is a side view of a screw for securing siding to a surface.

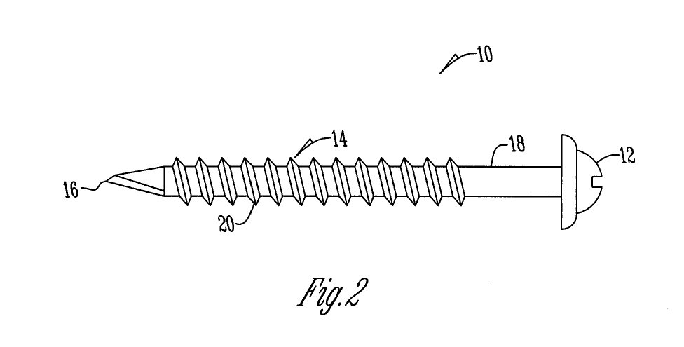

### DETAILED DESCRIPTION OF THE PREFERRED EMBODIMENT

Referring to the Figures, a screw 10 has a head 12. Preferably, the head 12 is formed similar to a pan head, wafer, “s”, truss head, or washer head screw. Also preferred is a head having at least a ⅜″ (9.5 mm) diameter.

Extending from the head 12 is a shaft 14 that terminates in a tip 16. The tip 16 is of different types such as a drill point, sharp point, or the like. Optimally, the shaft has at least a ⅛″ (3 mm) diameter and at least a length of 1⅛″ (29 mm). The shaft has a first or substantially smooth portion 18 and a second or threaded portion 20 that extends outwardly from the smooth portion toward the tip 16. Optimally, the smooth portion 18 extends ½″ from the head 12.

While the screw may be used to apply the siding to a variety of surfaces, one example includes applying siding over metal studs. To begin a wall sheathing 22 is installed over the studs to provide a straighter, smoother, more rigid wall surface to help prevent the studs from twisting. The vinyl siding 24 is placed over the sheathing 22 and the screw 12 is inserted through a slot 26 in the siding 24. The screw 12 is rotated so that the threaded portion 20 bores into and is secured to the sheathing 22 to such a depth that the smooth portion 18 of the shaft 16 is positioned between the edges 28 of the slot 26 in the siding 24. In this manner, the vinyl siding 24 may slide along the length of the slot 26 in relation to the screw. Thus a screw has been described that at the very least meets the stated objective.

What is claimed is:

1. A screw for securing vinyl siding to a surface, comprising:
a head;
a shaft extending outwardly from the head and terminating in a tip;
the shaft having a first portion adjacent the head and having a substantially smooth surface and a second portion that is threaded and extends from the first portion toward the tip.

2. The screw of claim 1 wherein the first portion is at least ½″ in length.

3. The screw of claim 1 wherein the head is a wafer head.

4. The screw of claim 1 wherein the smooth portion of the shaft is adapted to be slidably received within edges of a slot in the vinyl siding.
